(19) United States
(12) Patent Application Publication
(10) Pub. No.: US 2026/0313357 A1
(43) Pub. Date: Oct. 8, 2026

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Yanhua LI, Beijing (CN); Xuemei QIAO, Beijing (CN)

(21) Appl. No.: 19/472,038

(22) PCT Filed: Apr. 6, 2023
(86) PCT No.: PCT/CN2023/086702

§ 371 Date: Oct. 2, 2025

(51) Int. Cl. H04W 8/22; H04W 28/20; H04W 74/0833; H04W 76/20

(52) U.S. Cl. CPC H04W 8/22; H04W 28/20; H04W 74/0833; H04W 76/20

(57) ABSTRACT

A method for processing information, including: sending first information to a network device, where the terminal initially accesses a network in a first mode, and the first information is configured for the network device to determine whether the terminal supports or expects to operate in a second mode.

### CROSS-REFERENCE TO RELATED APPLICATIONS

The present application is a U.S. National Stage of International Application No. PCT/CN2023/086702, filed on Apr. 6, 2023, the contents of all of which are incorporated herein by reference in their entirety for all purposes.

### BACKGROUND OF THE INVENTION

Reduced Capability (Redcap) User Equipment (UE) is also known as a RedCap terminal, a New Radio (NR) lite terminal, or a 5th Generation (5G) light terminal. The RedCap terminal is similar to a Long-Term Evolution (LTE) device, and usually has the following characteristics: low cost, low structural complexity, demand on certain coverage enhancement, and/or low power consumption.

### SUMMARY OF THE INVENTION

The present disclosure relates to, but is not limited to, the technical field of wireless communications, and in particular, to a method and device for processing information, a communication device, and a storage medium. Embodiments of the present disclosure provide a method and device for processing information, a communication device, and a storage medium.

A first aspect of the embodiments of the present disclosure provides a method for processing information. The method is performed by a terminal and includes:
sending first information to a network device, where the terminal initially accesses a network in a first mode, and the first information is configured for the network device to determine whether the terminal supports or expects to operate in a second mode.

A second aspect of the embodiments of the present disclosure provides a method for processing information. The method is performed by a network device and includes:
receiving first information from a terminal, where the terminal initially accesses a network in a first mode, and the first information is configured for the network device to determine whether the terminal supports or expects to operate in a second mode.

A third aspect of the embodiments of the present disclosure provides a communication device. The communication device includes one or more processors; a memory, and an executable program stored in the memory and capable of being run by the one or more processors, where the one or more processors, upon running the executable program collectively, cause the communication device to: send first information to a network device, where the terminal initially accesses a network in a first mode, and the first information is configured for the network device to determine whether the terminal supports or expects to operate in a second mode.

A fourth aspect of the embodiments of the present disclosure provides a non-transitory computer storage medium storing an executable program, where the executable program, when executed by one or more processors, implements the method for processing information provided in the first or second aspect.

It is to be understood that in the technical solution provided by the embodiments of the present disclosure, the general description above and the detailed description below are merely exemplary and explanatory, and do not limit the embodiments of the present disclosure.

### BRIEF DESCRIPTION OF DRAWINGS

The accompanying drawings here, which are incorporated in and constitute a part of this specification, illustrate the embodiments of the present disclosure, and, together with the specification, serve to explain the principles of the embodiments of the present disclosure.

FIG. 1A is a schematic structural diagram of a wireless communication system according to an example.

FIG. 1B is a comparative schematic diagram of a first mode and a second mode according to an example.

FIG. 2A is a schematic flowchart of a method for processing information according to an example.

FIG. 2B is a schematic flowchart of a method for processing information according to an example.

FIG. 2C is a schematic flowchart of a method for processing information according to an example.

FIG. 2D is a schematic flowchart of a method for processing information according to an example.

FIG. 2E is a schematic flowchart of a method for processing information according to an example.

FIG. 3A is a schematic flowchart of a method for processing information according to an example.

FIG. 3B is a schematic flowchart of a method for processing information according to an example.

FIG. 3C is a schematic flowchart of a method for processing information according to an example.

FIG. 3D is a schematic flowchart of a method for processing information according to an example.

FIG. 3E is a schematic flowchart of a method for processing information according to an example.

FIG. 4A is a schematic flowchart of a method for processing information according to an example.

FIG. 4B is a schematic flowchart of a method for processing information according to an example.

FIG. 5A is a schematic structural diagram of a terminal according to an example.

FIG. 5B is a schematic structural diagram of a network device according to an example

### DETAILED DESCRIPTION OF THE INVENTION

Examples will be described in detail here, instances of which are shown in the accompanying drawings. When the following description involves the accompanying drawings, unless otherwise indicated, the same numerals in different accompanying drawings refer to the same or similar elements. Implementations described in the examples below do not represent all implementations consistent with the embodiments of the present disclosure. Instead, these implementations are merely examples of devices and methods consistent with some aspects of the embodiments of the present disclosure.

Terms used in the embodiments of the present disclosure are merely for the purpose of describing particular embodiments and are not intended to limit the embodiments of the present disclosure. Singular forms “a,” “an,” and “the” as used in the present disclosure also include plural forms, unless the context clearly indicates otherwise. It is to be understood that the term “and/or” as used herein refers to and includes any or possible combinations of one or more of the associated listed items.

It is to be understood that although the terms such as “first,” “second,” and “third” may be used in the embodiments of the present disclosure to describe various pieces of information, these pieces of information are not expected to be limited to these terms. These terms are merely used to distinguish information of the same type from one another. For example, first information may also be referred to as second information, and similarly, second information may be referred to as first information, without departing from the scope of the embodiments of the present disclosure. The word such as “if” as used here may be interpreted as “in a case where,” or “in a case of,” or “in response to determining,” depending on the context.

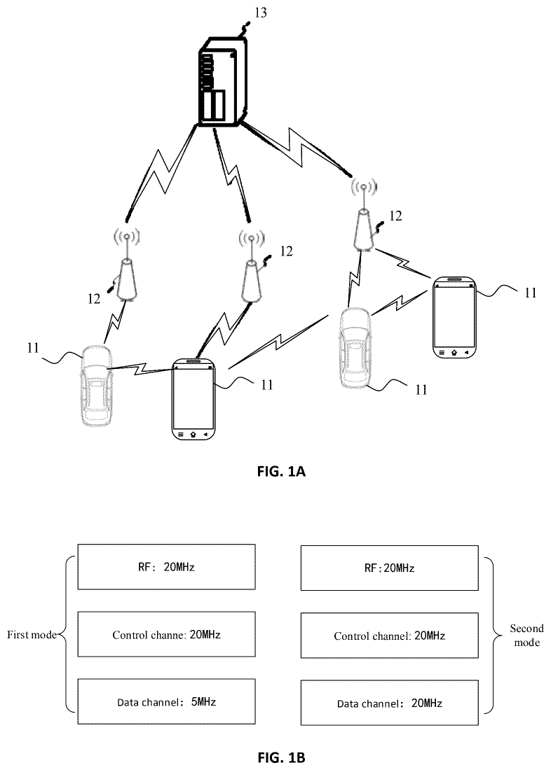

Referring to FIG. 1A, FIG. 1A illustrates a schematic structural diagram of a wireless communication system according to the embodiments of the present disclosure. As shown in FIG. 1A, the wireless communication system is a communication system based on a cellular mobile communication technology. The wireless communication system may include: a plurality of UEs 11, one or more access devices 12, and one or more core network devices 13.

The UEs 11 may refer to devices providing voice and/or data connectivity for a user. The UEs 11 may communicate with one or more core networks via a Radio Access Network (RAN). The UEs 11 may be Internet or Things UEs, such as sensor devices, mobile phones (also known as “cellular” phones), or computers with Internet of Things UEs. For example, the UEs may be fixed, portable, pocket-sized, handheld, computer-integrated or vehicle-mounted devices, such as Stations (STAs), subscriber units, subscriber stations, mobile stations, mobiles, remote stations, access points, remote terminals, access terminals, user terminals, user agents, user devices, or user equipment (UE). Alternatively, the UEs 11 may also be devices of an unmanned aerial vehicle. Alternatively, the UEs 11 may also be vehicle-mounted devices, such as electronic control units with wireless communication functions, or external wireless communication devices for the electronic control units. Alternatively, the UEs 11 may also be roadside devices, such as streetlights, signal lights, or other roadside devices with wireless communication functions.

The access device 12 may be a network-side device in a wireless communication system. The wireless communication system may be the 4th generation mobile communication (4G) system, which is also known as a Long-Term Evolution (LTE) system. Alternatively, the wireless communication system may also be a 5G system, which is also known as a new radio (NR) system or a 5G NR system. Alternatively, the wireless communication system may also be a next-generation system beyond the 5G system, where an access network in the 5G system may be referred to as a New Generation-Radio Access Network (NG-RAN). Alternatively, the wireless communication system may also be an MTC system.

The access device 12 may be an evolved access device (eNB) in the 4G system. Alternatively, the access device 12 may also be an access device (gNB) with a centralized distributed architecture used in the 5G system. The access device 12, in a case of adopting the centralized distributed architecture, usually includes a central unit (CU) and at least two distributed units (DUs). The central unit is provided with protocol stacks for a Packet Data Convergence Protocol (PDCP) layer, a Radio Link Control (RLC) layer, and a Media Access Control (MAC) layer, and the distributed units are provided with protocol stacks for Physical (PHY) layers. The specific implementation of the access device 12 is not limited in the embodiments of the present disclosure.

A wireless connection may be established between the access device 12 and the UEs 11 via a wireless air interface. In different implementations, the wireless air interface is based on the 4th generation mobile communication (4G) standard. Alternatively, the wireless air interface is based on the 5^{th} generation (5G) standard, for example, the wireless air interface is a new radio (NR). Alternatively, the wireless air interface may also be based on a next-generation mobile communication standard beyond 5G.

The core network 13 may be connected with the access device 12. A typical core network device may include, but is not limited to, an Access and Mobility Management Function (AMF), a Session Management Function (SMF), a User Data Management (UDM), and a Policy Control Function (PCF).

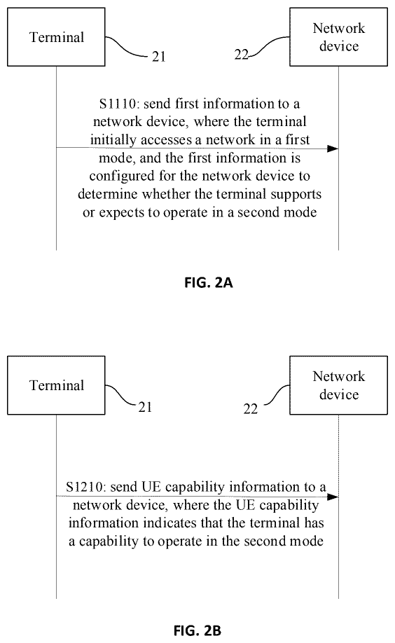

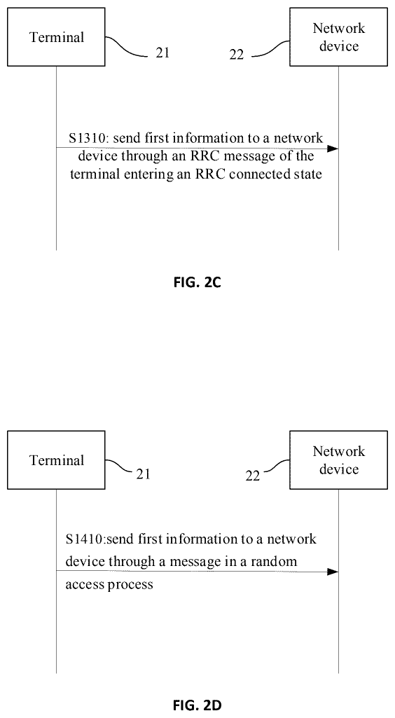

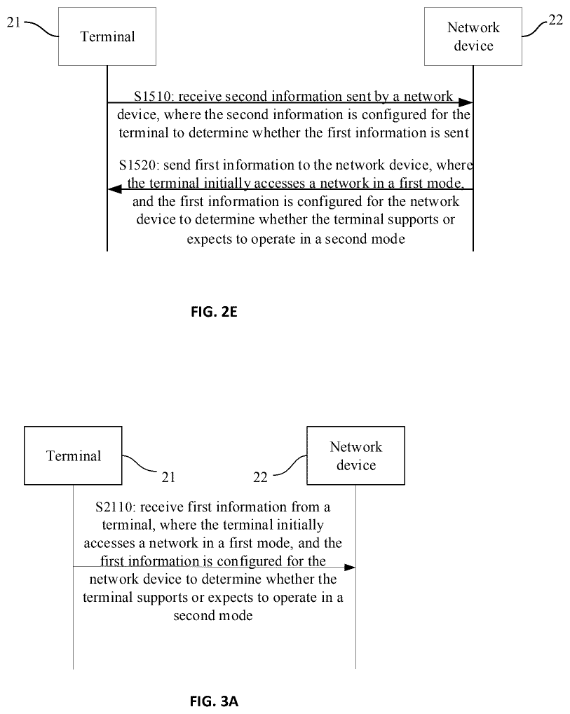

As shown in FIG. 2A, the embodiments of the present disclosure provide a method for processing information. The method is performed by a terminal 21 and includes the step S1110.

In step S1110, first information is sent to a network device 22, where the terminal 21 initially accesses a network in a first mode, and the first information is configured for the network device to determine whether the terminal 21 supports or expects to operate in a second mode.

According to the technical solution provided by the embodiments of the present disclosure, the terminal 21, upon initially accessing the network in the first mode, reports the first information to the network device 22, where the first information indicates whether the terminal 21 supports or expects to operate in the second mode. This enables the network device 22 to control the operating mode of the terminal 21 according to communication needs and/or system capacity, or to learn possible operating modes of the terminal 21.

For example, the terminal 21 may be a RedCap terminal or an enhanced mode eRedcap terminal.

Here, the Redcap terminal may support both the first mode and the second mode, or simply support the second mode.

The first mode and the second mode may be different operating modes of the terminal.

The network device 22 may be an access network device, etc.

For example, a peak data rate of the terminal operating in the second mode is higher than that of the terminal operating in the first mode; and/or a baseband bandwidth of a specified channel supported by the terminal operating in the second mode is greater than that of a specified channel supported by the terminal operating in the first mode.

For example, the peak data rate may include a max sending rate and/or a max reception rate.

For example, the peak data rate may be the max sending rate and/or the max reception rate for baseband transmission.

Here, the peak data rate may be understood as the max data rate in related art, or may also be a transmission rate calculated in a manner different from the max data rate.

FIG. 1B is a comparative schematic diagram of the first mode and the second mode.

In the first mode, the bandwidth supported by Radio Frequency (RF) is 20 MHz, the bandwidth supported by a control channel is 20 MHz, and the bandwidth supported by a data channel is 5 MHz. In the second mode, the bandwidth supported by the RF is 20 MHz, the bandwidth supported by the control channel is 20 MHz, and the bandwidth supported by the data channel is 20 MHz. The radio frequency may also be referred to as RF.

The terminal initially accesses in the first mode, meaning that the terminal enters the network by using a lower peak data rate or a smaller baseband bandwidth after being powered on or exiting a flight mode. Upon accessing the network, the first information may be sent to inform the network device whether the terminal can support the second mode, or expects to operate in the second mode after the initial access.

Here, whether the terminal supports the second mode includes: whether hardware and software of the terminal support operating in the second mode. For example, some RedCap terminals are low in cost, and a circuit related to baseband processing is simple. In this case, the RedCap terminal only supports the first mode with a lower peak data rate or a smaller baseband bandwidth in hardware, but does not support the second mode with a higher peak data rate and a larger baseband bandwidth.

Some terminals support operating in the second mode in hardware and software, but do not wish to operate in the second mode for purposes such as power consumption saving. In this case, the second information may indicate that the terminal does not expect to operate in the second mode.

For example, a terminal capability in the second mode is higher than that in the first mode. For another example, the power consumption overhead of the terminal operating in the second mode may be higher than that of the terminal operating in the first mode.

For another example, the first mode is an enhanced mode of the second mode, and the enhanced mode may be an operating mode for a terminal with a specific bandwidth and/or a terminal with lower power consumption.

For example, the first information may include one or more bits, and different bit values of these bits may represent two states of whether the terminal supports or expects to operate in the second mode.

For example, the specified channel here includes, but is not limited to, a data channel. The data channel may include, but is not limited to, a Physical Downlink Shared Channel (PDSCH) and/or a Physical Uplink Shared Channel (PUSCH).

In some embodiments, the first information indicates whether a random access of the terminal, after the initial access, supports or expects to operate in the second mode.

In the embodiments of the present disclosure, the terminal may send the first information to the network device by using any uplink message. For example, the terminal may send the first information to the network device by using an RRC message, a MAC layer message, or Uplink Control Information (UCI).

The MAC message may include, but is not limited to, a MAC layer Control Element (CE).

The terminal, by reporting the first information, can facilitate the network device in controlling the operating mode of the terminal according to communication needs and/or system capacity, or in learning possible operating modes of the terminal.

For example, in some embodiments, the network device may send control signaling according to the first information reported by the terminal, after the terminal reports the first information. The control signaling may indicate that the terminal operates in the first mode or the second mode.

For another example, in some embodiments, the terminal, after reporting the first information, may autonomously operate in the first mode or the second mode according to communication needs or protocol agreements. The network device learns the operating modes supported or expected by the terminal, or may also learn the operating modes of the terminal according to the protocol agreements.

In some embodiments, the terminal may send the first information to the network device through various RRC messages, in a case where the terminal is in an RRC connected state. For example, the RRC messages may reuse an RRC message sending other contents.

As shown in FIG. 2B, the embodiments of the present disclosure provide a method for processing information. The method is performed by a terminal 21 and includes the step S1210.

In step S1210, UE capability information is sent to a network device 22, where the UE capability information indicates that the terminal 21 has a capability to operate in the second mode.

The UE capability information is configured to report various capabilities of the terminal. Hence, there is no need to construct new message signaling or fields to report whether the terminal 21 supports to operate in the second mode, by using the UE capability information to report whether the terminal 21 supports the second mode.

The UE capability information may also be configured to report capabilities of the terminal 21 in other aspects. For example, the capabilities of the terminal 21 in the other aspects may include: whether the terminal 21 supports an extended discontinuous reception mechanism in an RRC inactive state, etc.

Definitely, this is merely an example, and the specific implementation is not limited to this example.

The UE capability information may send an RRC message to the network device when the UE is in an RRC connected state.

As shown in FIG. 2C, the embodiments of the present disclosure provide a method for processing information. The method is performed by a terminal 21 and includes the step S1310.

In step S1310, first information is sent to a network device 22 through an RRC message of the terminal entering an RRC connected state.

The first information may be sent to the network device 22 through the RRC message of the terminal 21 entering the RRC connected state, in a case where the terminal 21 is in an RRC disconnected state.

The RRC message may include, but is not limited to, at least one of the following:
an RRCResumeComplete message, where the RRCResumeComplete message may be configured for the terminal to notify the network device that the terminal enters the RRC connected state from the RRC disconnected state;
an RRC setup complete, i.e., RRCSetupComplete message, where the RRCSetupComplete message may be configured for the terminal to notify the network device that the terminal enters the RRC connected state from an RRC idle state; or
an RRCReestablishmentComplete message, where the RRCReestablishmentComplete message may be configured for the terminal to notify the network device that an RRC connection is reestablished. For example, the RRC connection may involve a Radio Bearer (RB) of the RRC connection. The RB may include: a Signal Radio Bearer (SRB) and/or a Data Radio Bearer (DRB).

In this case, the terminal in the RRC disconnected state may send the first information indicating whether it supports or expects to operate in the second mode to the network device during the process of the terminal entering the RRC connected state, allowing the network device to timely learn the capabilities or expectation of the terminal during the process of the terminal entering the RRC connected state. The RRC disconnected state here may include: an RRC idle state and/or an RRC inactive state.

In some embodiments, when the terminal sends an RRC message requesting to enter the RRC connected state for the purpose of transmitting the first information, the terminal may return to the RRC disconnected state after the sending of the first information is completed, without further responding to a response message of the network device and entering the RRC connected state. This reduces the number of times the terminal enters the RRC connected state and the duration the terminal remains in the RRC connected state, and hence, power consumption is reduced.

The network device, upon receiving the RRC message containing the first information, may send the response message to the terminal by responding to the RRC message according to an agreement, or may extract the first information from the RRC message and then ignore the RRC message without sending the response message to the terminal. As a result, unnecessary sending of the response message by the network device is reduced.

For example, when the RRC message carries a preset indicator, it may be considered that the RRC message is for the purpose of transmitting the first message, rather than indicating that the terminal needs to enter the RRC connected state. For another example, when the RRC message does not carry the preset indicator, it may be considered that the RRC message is from the terminal requesting to enter the RRC connected state and sending the first information to the network device during the process of entering the RRC connected state.

As shown in FIG. 2D, the embodiments of the present disclosure provide a method for processing information. The method is performed by a terminal 21 and includes the step S1410.

In step S1410, first information is sent to a network device 22 through a message in a random access process.

For example, in the embodiments of the present disclosure, sending the first information to the network device 22 by the terminal 21 using the message in the random access process may includes:
sending the first message in a Message (Msg) 1, a Msg 3 and/or a Msg A in the random access process.

In some embodiments, the terminal may also send the first information after completing the random access. For example, the terminal may also send the first information through a message 5 (Msg 5), where the message 5 refers to the RRCResumeComplete message, the RRCSetupComplete message, and the RRCReestablishmentComplete message mentioned above.

In some embodiments, the terminal may send the first message according to indications of the network device. The network device may indicate the terminal to report in a system message block or in a message 2 in the random access process, and the terminal may report the first information in the Msg 3.

Hence, the terminal reports the first message to the network device in the random access process.

For example, for the terminal in an RRC connected state, cell handover to a target cell from a source cell includes a random access. The random access may include: a contention-based random access and a contention-free random access. In the contention-free random access, the terminal may use a random access resource pre-configured by the target cell, where the random access resource pre-configured by the target cell may include: a predetermined random access preamble.

In some embodiments, the first information includes at least one of the following:
a preset parameter, where the preset parameter and a specified threshold are configured for the network device to determine whether the terminal supports or expects to operate in the second mode;
a first field, where the first field is configured to indicate whether the terminal supports or expects to operate in the second mode;
a second field, where the second field is configured to indicate whether the terminal supports the bandwidth for operating in the second mode; or
a third field, where the third field indicates that the terminal supports a reduction or increase in peak data rate, or indicates that the terminal supports a reduction or increase in baseband bandwidth.

The data rate transmitted by the terminal may be calculated by using the following formula:

$$data rate = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{P R B}^{BW ( j ) , μ} \cdot 12}{{T}_{s}^{μ}} \cdot ( 1 - {OH}^{( j )} ) )$$

where J is the number of single-band or cross-band carrier aggregations, and j is the sequence number of an aggregated carrier;

$${v}_{Layers}^{〈 j )}$$

is the maximum number of layers supported by a j-th carrier, such as the maximum number of layers for a PUSCH and/or a PDSCH;

$${Q}_{m}^{( j )}$$

is the maximum modulation order;
f^{(j)} is a scaling factor for the j-th carrier;

$${N}_{P R B}^{BW ( j ) , μ} .$$

is the maximum Resource Block (RB) with u for bandwidth BW^{(j)}, and BW^{(j)} is the maximum bandwidth supported by the terminal in a specified band;
Tₛ^{μ} is the maximum duration of one Orthogonal Frequency Division Multiplexing (OFDM) symbol in one subframe corresponding to u; and
OH^{(j)} is an overhead value corresponding to the j-th carrier, specifically as follows:
0.14 for downlink transmission in a Frequency Range (FR) 1
0.18 for downlink transmission in an FR2;
0.08 for uplink transmission in the FR1; and
0.10 for uplink transmission in the FR2.

The formula may be an optional manner for calculating the peak data rate.

In the embodiments of the present disclosure, the preset parameter may be any parameter for calculating the data rate. Specifically, the preset parameter may be any one of

$${v}_{Layers}^{〈 j )} , {Q}_{m}^{( j )} ,$$

and f^{(j)}.

The specified threshold may be any preset parameter that determines whether the terminal supports or expects to operate in the second mode. The specified threshold may be a value agreed upon by a protocol or a threshold specified by the network device.

In some embodiments, the product of

$${v}_{Layers}^{( j )} * {Q}_{m}^{( j )} * {f}^{( j )}$$

is compared with the specified threshold; and a comparison result is configured to determine whether the terminal supports or expects to operate in the second mode. For example, the specified threshold may be values such as 4, 3, 3.2, 1 or 0.75, and the like.

Here, the product of

$${v}_{Layers}^{( j )} * {Q}_{m}^{( j )} * {f}^{( j )}$$

may represent the aforementioned peak data rate to a certain extent. The specified threshold here may be any value determined by protocol agreements or other manners.

For another example, the preset parameter may be f^{(j)}. In this case, the specified threshold may be other preset value that may be compared with f^{(j)}.

It is worth noting that for a cell supporting a Supplement UL Link (SUL) carrier, the calculation of a UL carrier and an SUL carrier that support higher data rate may be included during calculation of the number of carriers.

For UL reception switching of the terminal between different carriers, carriers that support Multiple Input Multiple Output (MIMO) layer merging between carriers to result in higher rate are merely counted in the number of carriers.

The maximum data rate supported by the terminal may be configured to calculate the maximum uplink rate supported by the terminal through the above formula.

For the terminal operating in the second mode, the product

$${v}_{Layers}^{( j )} * {Q}_{m}^{( j )} * {f}^{( j )}$$

greater than or equal to 4, in a case where the terminal resides in a single-carrier cell.

In some embodiments, the first information may be carried by any one of a first field, a second field, and a third field.

The first field carries mode information. The mode information may include a mode identifier, etc. The first field may include one or more bits. The first field indicates that the terminal supports or expects to operate in the second mode, in a case where the first field carries information of the second mode.

The second field may carry the maximum bandwidth supported by the terminal or a bandwidth in which the terminal expects to operate. For example, the second field may carry the baseband bandwidth supported by the terminal for the specified channel or the baseband width in which the terminal expects to operate. Hence, the network device may learn, according to the second field, the baseband bandwidth supported or expected by the terminal to operate in, and further learn whether the terminal supports or expects to operate in the second mode.

The third field directly indicates whether the terminal supports a reduction or increase in the peak data rate. It is indicated that the terminal supports or expects to operate in the second mode, in a case where the terminal initially accesses in the first mode and the third field indicates that the terminal supports the reduction or increase in the peak data rate. Otherwise, the terminal does not support or expect to operate in the second mode.

The above are merely a few examples of the first information, and the specific implementation is not limited to the above examples.

In some embodiments, the capability of the terminal to support or expect to operate in the second mode is based on a UE, a band, or a frequency range.

It is indicated that the entire terminal supports or expects to operate in the second mode regardless of a frequency domain position supportable by the terminal, in a case where the capability of the terminal to support or expect to operate in the second mode is based on the UE.

A system bandwidth used by the wireless communication system may be divided into one or more bands. One band includes one or more frequency points.

The terminal may support or expect to operate in the second mode in part of the bands, or may not support or expect to operate in the second mode in part of the bands.

The terminal may support or expect to operate in the second mode within one or more frequency ranges. For example, the terminal supports or expects to operate in the second mode in the Frequency Range (FR) 1 and/or the FR2.

The frequency range of the FR1 may be 450 MHz to 6,000 MHz, which is also known as Sub 6G.

The frequency range of the FR2 may be 24,250 MHz to 52,600 MHz, and the corresponding maximum system bandwidth may be 400 MH.

One frequency range may include one or more bands.

In some embodiments, the first information further includes range information. The range information indicates that the terminal supports or expects to operate in the second mode based on the entire UE, or based on the band, or based on the frequency range.

For example, the range information may include a band identifier, in a case where the terminal expects or operates in the second mode based on the band. The range information may include a range identifier of the frequency range, etc., in a case where the terminal expects or operates in the second mode based on the frequency range.

Here is merely an example, and the specific implementation is not limited to this example.

As shown in FIG. 2E, the embodiments of the present disclosure provide a method for processing information. The method is performed by a terminal 21 and includes the steps S1510 and S1520.

In step S1510, second information sent by a network device 22 is received, where the second information is configured for the terminal 21 to determine whether the first information is sent.

In step S1520, the first information is sent to the network device 22, where the terminal 21 initially accesses a network in a first mode, and the first information is configured for the network device 22 to determine whether the terminal supports or expects to operate in a second mode.

For example, the second information may be any information indicating the terminal to report whether it supports the second mode.

In one embodiment, the second information is sent, in a case where the network device needs the terminal to send the first information; and the second information is not sent, in a case where the network device does not need the terminal to send the first information. In this case, a reception state of the second information indicates whether the terminal reports the first information. For example, it is considered that the first information needs to be sent to the network device, in a case where the terminal successfully receives the second information. It is considered that the first information does not need to be sent to the network device, in a case where the terminal does not receive the second information.

In another embodiment, after receiving the second information, the terminal determines, according to information content of the second information, whether the first information needs to be sent, in a case where the network device uses information content of the first information to indicate whether the terminal sends the second information. For example, the terminal sends the first information to the network device, in a case where the second information indicates that the first information needs to be sent. The terminal does not send the first information to the network device, in a case where the second information indicates that the first information does not need to be sent.

In some embodiments, the second information includes at least one of the following:
a first indication, indicating whether the terminal needs to report UE Assistance information (UAI);
a second indication, indicating whether the network device supports or activates the first mode; or
a third indication, indicating whether the network device is a predetermined type of device, where the predetermined type of device supports the first mode.

In some embodiments, the second information is the first indication, which is configured to inform the terminal whether to report the UAI.

In a case where the first information of the terminal is reported in the UAI, upon receiving the first indication that indicates to report the UAI, the terminal reports the first information through the UAI.

In a case where the first information of the terminal is not reported in the UAI and reported, even if the terminal receives the first indication that indicates to report the UAI, the terminal needs to determine, according to its own needs or other types of second information, whether to report the first information.

In a case the first information of the terminal is reported in the UAI, the terminal does not report the first information upon receiving the first indication that indicates not to report the UAI.

In a case where the first information of the terminal is not reported in the UAI, even if the terminal receives the first indication that indicates not to report the UAI, the terminal needs to determine, according to its own needs or other types of second information, whether to report the first information.

It is indicated that the network device enhances the operating mode based on the second mode, in a case where the network device supports the first mode. Hence, the network device may support the terminal to continue operating in the first mode, after the terminal accesses the network through the first mode. Further, since the network device originally allows the terminal to operate in the second mode, in this case, it is equivalent to the network device allowing the terminal to select to operate in the first mode or the second mode.

For example, the second indication indicates that the network device supports or has activated the first mode. And the terminal may report the first information to indicate whether it supports or expects to operate in the second mode.

In another example, the second indication indicates that the network device does not support or has not activated the first mode. And the terminal may not report the first information to indicate whether it supports or expects to operate in the second mode.

As mentioned above, the first mode may be an enhanced mode of the second mode. The network device may classify device types according to whether the first mode is supported. The third information indicates the device type of the network device. It is indicated that the network device supports or has activated the first mode, in a case where the device type indicated by the third information is a predetermined device type. Otherwise, it may be considered that the network device does not support or has not activated the first mode.

For example, the third indication indicates that the network device is the predetermined type of device, and the terminal sends the first information to the network device.

In another example, the third indication indicates that the network device is not the predetermined type of device, and the terminal does not send the first information to the network device.

In some embodiments, the method further includes:
upon receiving the second indication indicating that the network device does not support or has not activated the first mode, or upon receiving an indication indicating that the network device is not the predetermined type of device, switching, by the terminal, its operating mode to the second mode after completion of the initial access. In other words, the terminal communicates with the network device based on the second mode.

In some embodiments, the second information may further include scheduling information. The scheduling information may be configured to schedule a resource and/or a sending mode for the terminal to send the first information.

For example, the scheduling information may indicate that the first information is sent through an RRC resume request message, an RRC reestablishment message, an RRC setup message, or a random access message when transitioning to the RRC connected state from the RRC disconnected state.

For example, sending the first message to the network includes at least one of the following:
sending UAI containing the first message to the network device, upon determining, based on the first indication, that the UAI needs to be reported;
sending the first information to the network device, upon determining, based on the second indication, that the network device supports or has activated the first mode; or
sending the first information to the network device, upon determining, based on the third indication, that the network device is the predetermined type of device.

In the embodiments of the present disclosure, the first information may be reported merely when necessary according to the indication of the network device or the network capability of the network device to support the first mode. Otherwise, the first information is not reported. Hence, the signaling overhead of the terminal is reduced.

In some embodiments, receiving the second information sent by the network device includes at least one of the following:
receiving a system message block sent by the network device, where the system message block includes the second information; or
receiving a dedicated message sent by the network device, where the dedicated message includes the second information.

The terminal may receive the system message block broadcast by the network device in the RRC connected state and the RRC disconnected state. Further, the system message block may be received by all terminals in a cell. Hence, by carrying the second information in the system message block, the terminal may receive the second message without switching RRC states. In addition, all the terminals in the cell that need the second information may receive it. This eliminates the need for the network device to send the second information to a terminal group or an individual terminal.

For example, in this case, both the first mode and the second mode involve a RedCap terminal, and the system information block carrying the second information may be a dedicated system message block for the RedCap terminal.

In some embodiments, the dedicated message may be an RRC message, or the like, sent to an individual terminal. Hence, the terminal receives the second information through the dedicated message, allowing for precise control over the reporting of the first information by the individual terminal.

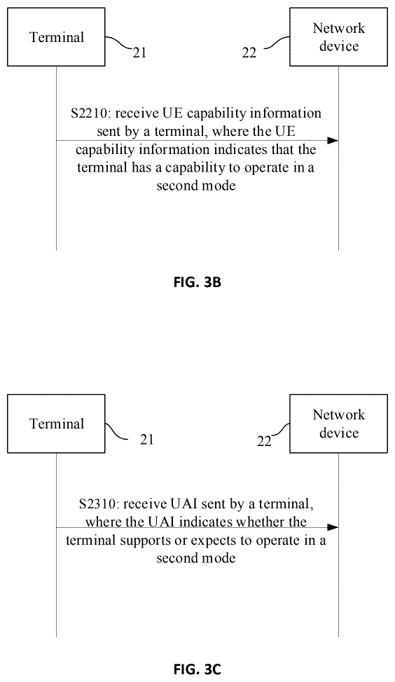

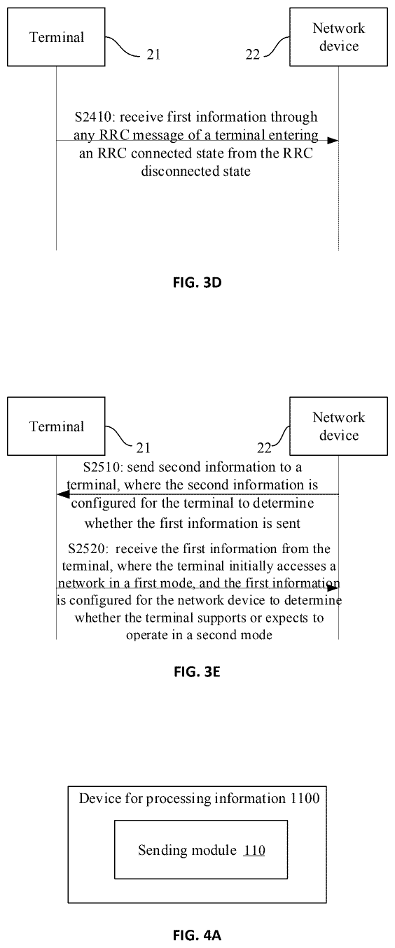

As shown in FIG. 3A, the embodiments of the present disclosure provide a method for processing information. The method is performed by a network device 22 and includes the step S2110.

In step S2110, first information from a terminal 21 is received, where the terminal 21 initially accesses a network in a first mode, and the first information is configured for the network device 22 to determine whether the terminal 21 supports or expects to operate in a second mode.

The network device 22 may be any access device. The access device may be an evolved base station and/or a next-generation base station.

The terminal 21 here may be any type of UE.

For example, the terminal 21 may be a RedCap terminal or an enhanced mode eRedcap terminal.

For example, a peak data rate of the terminal operating in the second mode is higher than that of the terminal operating in the first mode; and/or a baseband bandwidth of a specified channel supported by the terminal operating in the second mode is greater than that of a specified channel supported by the terminal operating in the first mode.

For example, the peak data rate may include a max sending rate and/or a max reception rate.

For example, the peak data rate may be the max sending rate and/or the max reception rate for baseband transmission.

The terminal initially accesses the network through the first mode, meaning that the terminal enters the network by using a lower peak data rate or a smaller baseband bandwidth after being powered on. Upon accessing the network, the first information can be sent to inform the network device whether the terminal can support the second mode, or whether it expects to operate in the second mode.

Whether the terminal supports the second mode includes: whether hardware and software of the terminal support operating in the second mode. For example, some RedCap terminals are low in cost, and a circuit related to baseband processing is simplified again. In this case, the RedCap terminal simply supports the first mode with a lower peak data rate or a smaller baseband bandwidth in hardware, but does not support the second mode with a higher peak data rate and a larger baseband bandwidth.

Some terminals support to operate in the second mode, but do not wish to operate in the second mode due to power consumption saving and other purposes. In this case, the second information can indicate that the terminal does not expect to operate in the second mode.

For example, the terminal capability in the second mode is higher than that in the first mode. For another example, the power consumption overhead of the terminal operating in the second mode may be higher than that of the terminal operating in the first mode.

In another example, the first mode is an enhanced mode of the second mode, and the enhanced mode may be an operating mode for a terminal with a specific bandwidth and/or a terminal with lower power consumption.

For example, the first information may include one or more bits, and different bit values of these bits may represent two states of whether the terminal supports or expects to operate in the second mode.

For example, the specified channel here includes, but is not limited to, a data channel. The data channel may include, but is not limited to, a Physical Downlink Shared Channel (PDSCH) and/or a Physical Uplink Shared Channel (PUSCH).

For example, the first information is carried in an RRC message, a MAC layer message, or Uplink Control Information (UCI). The MAC message may include, but is not limited to, a MAC layer Control Element (CE).

For example, the second information specifically indicates to the network device whether the terminal supports or expects to operate in the second mode after the initial access.

As shown in FIG. 3B, the embodiments of the present disclosure provide a method for processing information. The method is performed by a network device and includes the step S2210.

In step S2210, UE capability information sent by a terminal is received, where the UE capability information indicates that the terminal has a capability to operate in a second mode.

As shown in FIG. 3C, the embodiments of the present disclosure provide a method for processing information. The method is performed by a network device and includes the step S2310.

In step S2310, UAI sent by a terminal is received, where the UAI indicates whether the terminal supports or expects to operate in a second mode.

As shown in FIG. 3D, the embodiments of the present disclosure provide a method for processing information. The method is performed by a network device and includes the step S2410.

In step S2410, first information is received through any RRC message of a terminal entering an RRC connected state from the RRC disconnected state.

For example, the RRC message may include, but is not limited to, at least one of the following:
an RRCResumeComplete message, where the RRCResumeComplete message may be configured for the terminal to notify the network device that the terminal enters the RRC connected state from the RRC disconnected state;
an RRCSetupComplete message, where the RRCSetupComplete message may be configured for the terminal to notify the network device that the terminal enters the RRC connected state from an RRC idle state; or
an RRCReestablishmentComplete message, where the RRCReestablishmentComplete message may be configured to for the terminal to notify the network device that an RRC connection is reestablished. For example, the RRC connection may involve a Radio Bearer (RB) of the RRC connection. The RB may include: a Signal Radio Bearer (SRB) and/or a Data Radio Bearer (DRB).

For example, the step S2410 may include: receiving the first information sent by the terminal through a message in a random access process. For example, the message in the random access process includes the radio resource control RRCSetupComplete message.

It is indicated that the terminal completes access, when the network device receives the RRCSetupComplete message. In this case, the network device may send, based on considerations regarding communication needs and/or system capacity, control signaling to the terminal according to the first information, in a case where the first information is carried in the RRCSetupComplete message. The control signaling may control the terminal to operate in the first mode or the second mode.

In summary, the terminal, by reporting the first information, can facilitate the network device in controlling the operating mode of the terminal according to the communication needs and/or the system capacity, or in learning possible operating modes of the terminal.

In some embodiments, the first information includes at least one of the following:
a preset parameter, where the preset parameter and a specified threshold are configured for the network device to determine whether the terminal supports or expects to operate in the second mode;
a first field, where the first field is configured to indicate whether the terminal supports or expects to operate in the second mode;
a second field, where the second field is configured to indicate whether the terminal supports the bandwidth for operating in the second mode; or
a third field, where the third field indicates that the terminal supports a reduction or increase in the peak data rate, or indicates that the terminal supports a reduction or increase in the baseband bandwidth.

The preset parameter here may include, but is not limited to, any one of

$${v}_{Layers}^{( j )} , {Q}_{m}^{( j )} ,$$

and f^{(j)}.

For example, the network device and the terminal agree on some of parameters, while other parameters are reported by the terminal. In this way, the terminal, when reporting, can determine parameter values of parameters to be reported according to a mode supported by the terminal. As a result, the network device, after receiving the reported values from the terminal, calculates the product of the three parameters and compares the product with the specified threshold to learn whether the terminal can support or expects to operate in the second mode.

In some embodiments, the first information may be carried by any one of the first field, the second field, and the third field.

The first field carries mode information, and the mode information may include a mode identifier, etc. The first field may include one or more bits. The first field indicates that the terminal supports or expects to operate in the second mode, in a case where the first field carries information of the second mode.

The second field may carry the maximum bandwidth supported by the terminal or a bandwidth in which the terminal expects to operate. For example, the second field may carry a baseband bandwidth supported by the terminal for a specified channel or a baseband bandwidth in which the terminal expects to operate. In this way, the network device can learn, according to the second field, the baseband bandwidth supported or expected by the terminal to operate in, and further learn whether the terminal supports or expects to operate in the second mode.

The third field directly indicates whether the terminal supports a reduction or increase in the peak data rate. It is indicated that the terminal supports or expects to operate in the second mode, in a case where the terminal initially accesses in the first mode and the third field indicates that the terminal supports the reduction or increase in the peak data rate. Otherwise, the terminal does not support or expect to operate in the second mode.

The above are merely a few examples of the first information, and the specific implementation is not limited to the above examples.

In some embodiments, the capability of the terminal to support or expect to operate in the second mode is based on a UE, a band, or a frequency range.

It is indicated that the entire terminal supports or expects to operate in the second mode regardless of a frequency domain position supportable by the terminal, in a case where the capability of the terminal to support or expect to operate in the second mode is based on the UE.

A system bandwidth used by the wireless communication system may be divided into one or more bands. One band includes one or more frequency points.

The terminal may support or expect to operate in the second mode in part of the bands, or may not support or expect to operate in the second mode in part of the bands.

The terminal may support or expect to operate in the second mode within one or more frequency ranges. For example, the terminal supports or expects to operate in the second mode in a Frequency Range (FR) 1 and/or an FR2.

The frequency range of the FR1 may be 450 MHz to 6,000 MHz, which is also known as Sub 6G.

The frequency range of the FR2 may be 24,250 MHz to 52,600 MHz, and the corresponding maximum system bandwidth may be 400 MH.

One frequency range may include one or more bands.

In some embodiments, the terminal needs to send the first information by default, or whether the first information needs to be sent is determined according to protocol agreements.

As shown in FIG. 3E, the embodiments of the present disclosure provide a method for processing information. The method is performed by a network device 22 and includes the steps S2510 and S2520.

In step S2510, second information is sent to a terminal 21, where the second information is configured for the terminal 21 to determine whether first information is sent.

In step S2520, the first information from the terminal 21 is received, where the terminal initially accesses a network in a first mode, and the first information is configured for the network device 22 to determine whether the terminal supports or expects to operate in a second mode.

In the embodiments of the present disclosure, the network device sends the second information to the terminal according to its own needs. It can be determined, according to the second information, whether the first information is sent to the network device, after the second information is received by the terminal.

The network device may receive the first information according to the second information, after the second information is sent to the network device.

For example, the second information may indicate whether the terminal needs to report the first information.

For another example, the second information, when indicating that the terminal reports the first information, may also be configured to schedule a resource and/or a report mode for the terminal to send the first information.

In some embodiments, the second includes at least one of the following:
a first indication, indicating whether the terminal needs to report UAI;
a second indication, indicating whether the network device supports or activates the first mode; or
a third indication, indicating whether the network device is a predetermined type of device, where the predetermined type of device supports the first mode.

In some embodiments, the second information is the first indication, which is configured to inform the terminal whether to report the UAI.

The terminal reports the first information through the UAI upon receiving the first indication that indicates to report the UAI, in a case where the first information of the terminal is reported in the UAI.

The terminal needs to determine, according to its own needs or other types of second information, whether to report the first information even if the terminal receives the first indication that indicates to report the UAI, in a case where the first information of the terminal is not reported in the UAI.

The terminal does not report the first information upon receiving the first indication that indicates not to report the UAI, in a case the first information of the terminal is reported in the UAI.

The terminal needs to determine, according to its own needs or other types of second information, whether to report the first information even if the terminal receives the first indication that indicates not to report the UAI, in a case where the first information of the terminal is not reported in the UAI.

It is indicated that the network device enhances the operating mode based on the second mode, in a case where the network device supports the first mode. In this way, the network device can support the terminal to continue operating in the first mode, after the terminal accesses the network through the first mode. Further, since the network device originally allows the terminal to operate in the second mode, in this case, it is equivalent to the network device allowing the terminal to select to operate in the first mode or the second mode.

For example, the second indication indicates that the network device supports or has activated the first mode, and the terminal may report the first information to indicate whether it supports or expects to operate in the second mode.

In another example, the second indication indicates that the network device does not support or has not activated the first mode, and the terminal may not report the first information to indicate whether it supports or expects to operate in the second mode.

As mentioned above, the first mode may be an enhanced mode of the second mode. The network device may classify device types according to whether the first mode is supported. The third information indicates the device type of the network device. It is indicated that the network device supports or has activated the first mode, in a case where the device type indicated by the third information is the predetermined device type. Otherwise, it may be considered that the network device does not support or has not activated the first mode.

For example, the third indication indicates that the network device is the predetermined type of device, and the terminal sends the first information to the network device.

For another example, the third indication indicates that the network device is not the predetermined type of device, and the terminal does not send the first information to the network device.

In some embodiments, sending the second information to the terminal includes at least one of the following:
sending a system message block, where the system message block includes the second information; or
sending a dedicated message to the terminal, where the dedicated message includes the second information.

In the embodiments of the present disclosure, the second information may be broadcast to the terminal by being carried in the system message block, or unicast to the terminal by being carried in the dedicated message.

In other embodiments, the network device may also multicast the second information to every terminal in a terminal group through a multicast message.

The embodiments of the present disclosure provide a method for processing information. The method may be configured for an operating mode of a specific type of terminal.

The specific type of terminal may include, but is not limited to, a Redcap terminal.

The specific type of terminal may include an R18 version Redcap terminal, or may also be an R17 version Redcap terminal. The terminal capability of the R17 version Redcap terminal may be stronger, which may be compatible with the terminal capabilities defined by both R18 and R17 versions.

For example, the terminal supports the terminal capability defied by the R18 version, meaning that the terminal may operate in the first mode during the initial access.

The first mode may be an operating mode with a reduced peak data rate and/or a smaller narrowband.

For example, reducing the peak data rate may lower the peak data rate of the terminal to 10 Mbps, where the peak data rate includes an uplink peak data rate and/or a downlink peak data rate.

For example, the scheduling of a data channel operates with a lower bandwidth, such as 5 MHz. The specific characteristics are as follows:
specifically:
a 5 MHz baseband (BB) bandwidth is simply configured for a PDSCH and a PUSCH, while a 20 MHz RF band is configured for other UL and DL channels. In this case, the 5 MHz bandwidth may be configured to broadcast or unicast the PDSCH, and other physical channels and signals are still allowed to use a 20 MHz Bandwidth Part (BWP).

In a case where the terminal supports the first mode, it is equivalent that conditions for the peak data rate limit to be met may include:
for the peak data rate, its constraint may be relaxed according to

$${v}_{Layers}^{( j )} * {Q}_{m}^{( j )} * {f}^{( j )} ,$$

and the value

$${v}_{Layers}^{( j )} * {Q}_{m}^{( j )} * {f}^{( j )}$$

of may be reduced to a first value. The first value is less than or equal to 4, such as reduced to 3.2 or 0.75, and the like.

The specific type of terminal operates in the first mode during the initial access, and then inform the network device of the capability of the terminal to operate in the second mode after the initial access.

As an embodiment, assistance information reported by the terminal includes whether the terminal has the capability to operate in the second mode, or whether the terminal expects to operate in the second mode or the first mode.

For this specific type of terminal, whether it may operate in the second mode is optional.

For example, the specific type of terminal may operate in the second mode after completion of a random access.

As an embodiment, the terminal reports an indication to the network through a UE capability or reports assistance information to the network through UAI.

As an embodiment, the terminal reports assistance information to the network through a message 5. This message may include an RRCSetupComplete message, an RRCReestalishmentComplete message, or an RRCResumeComplete message.

As an embodiment, the second mode is:
an operating mode with a higher peak data rate and/or a larger narrowband, for example, operating with a larger bandwidth in data channel scheduling, such as 20 MHz.

Specifically:
the terminal, when operating in the second mode, may indicate the transmission of a PDSCH and a PUSCH by using a baseband bandwidth of 20 MHz. For example, the unicat or broadcast of the PDSCH is supported by using the baseband bandwidth of 20 MHz. For UL and DLC transmission, an RF transmission of 20 MHz may be supported.

For the peak data rate, its constraint may include: a value of

$${v}_{Layers}^{( j )} * {Q}_{m}^{( j )} * {f}^{( j )}$$

is reduced to a second value, and the second value may not be less than the first value. The second value may be the same as the first value. In this case, the constraint of the peak data rate remains unchanged during the initial access process and after completion of the initial access.

The first value and the second value may be one of the aforementioned specified thresholds.

As an embodiment, the terminal may report an indication that it operates with a larger bandwidth in data channel scheduling, or may display an indication of the maximum bandwidth for its data channel scheduling.

As an embodiment, the terminal may report its supportOfRedCapPR1-r18. The supportOfRedCapPR1-r18 indicates whether the terminal supports the second mode, or whether the supportOfRedCapPR1-r18 is an optional terminal capability.

As an embodiment, the terminal may report its supportedRedCap-R17. The supportedRedCap-R17 may be understood as a Field or an Information Element (IE) and may be configured to indicate whether the terminal supports the second mode.

As an embodiment, the terminal may report whether it supports a feature of a reduction or increase in the peak data rate, such as using one value Peak-datarate-reduction-RedCap-r18. The Peak-datarate-reduction-RedCap-r1 may be understood as a Field or an Information Element (IE) and may be configured to indicate whether the terminal supports the reduction or increase in the peak data rate.

The above fields or IEs may be reported individually, or in any combination.

For example, the terminal, after entering the RRC connected state, reports one or more of the following parameter combinations:
an option 1: reporting that the product of

$${v}_{Layers}^{( j )} , {Q}_{m}^{( j )} ,$$

and f^{(j)} is less than 4;
an option 2: reporting supportedRedCap-R17; and
an option 3: reporting whether a BB bandwidth of 20 MHz is supported.

$${v}_{Layers}^{( j )} , {Q}_{m}^{( j )} ,$$

and f^{(j)} may be reported individually or partially, when parameters are reported. For example, only one of the following is reported:

$${v}_{Layers}^{( j )} * {Q}_{m}^{( j )} * {f}^{( j )} < 3.2 .$$

The first information may also directly indicate whether the baseband bandwidth of 20 MHz is supported.

In some embodiments, a plurality of options may be combined for reporting when the first information is reported. For example, information of both the option 1 and the option 2 is simultaneously reported in the first information. In another example, information of both the option 1 and the option 3 is simultaneously reported in the first information.

As an embodiment, the specific type of terminal operates in the first mode during the initial access, and then informs the network device of assistance information. The network device is notified, through the assistance information, of a capability of the terminal to operate or expect to operate in the second mode after the initial access. The capability of the second mode is not supported by all terminals. Hence, one terminal capability indication may be introduced, which indicates whether the terminal has the capability to operate in the second mode after the initial access. The reporting of the terminal capability may be based on a single UE, a single band, or a single frequency range.

The terminal capability involved in the embodiments of the preset disclosure indicates whether the terminal has the capability to inform the network device of assistance information and notify that the terminal operates in the second mode after the initial access. The relevant capability of the terminal may refer to one embodiment in Table 1:

TABLE 1

| | | | Difference | |
|---|---|---|---|---|
| | | | between | |
| | | | frequency | |
| | | | division | |
| | | | multiplexing | |
| | | | (FDM) and | Difference |
| | | | time division | between |
| | Granularity or | | multiplexing | FR1 and |
| Parameter Definition | unit (PER) | Mandatory? | (TDM) | FR2 |
| Peak-datarate-reduction-RedCap-r18: | Terminal | No | None | None |
| indicating whether the terminal supports a | | | | |
| reduction or increase in the peak data rate | | | | |
| in the RRC connected or after the initial | | | | |
| access. | | | | |
| For the terminal, supporting the reduction | | | | |
| or increase in the peak data rate is an | | | | |
| optional terminal capability. | | | | |

The specific type of terminal operates in the first mode during the initial access and then informs the network device of assistance information. The assistance information may indicate the terminal to report whether it supports or expects to operate in the second mode, and the reporting needs to be done based on an indication of a base station.

As an embodiment, the terminal may report the assistance information, in a case where the base station indicates that the terminal may report the assistance information. Otherwise, the terminal does not need to report the assistance information. The assistance information may include, but is not limited to, the UAI.

As an embodiment, the terminal may report the first information, in a case where the indication of the base station may be a switch indicating whether the terminal is allowed to report. For example, the indication of the base station is a switch for the network device to support a reduction or increase in the peak data rate, and in a case where the switch is configured or set to true. Otherwise, the terminal does not need to report the first information.

As an embodiment, the base station is a base station supporting the access of an R18 enhanced Redcap terminal or the access of an R10 enhanced Redcap PR1 terminal.

As an embodiment, the indication of the base station may notify the terminal in a system message or dedicated signaling whether the base station supports the access of an R18 enhanced Redcap terminal.

The dedicated signaling may include, but is not limited to, an RRC reestablishment message.

The present disclosure protects the definition of a Rel18 eRedCap terminal. The terminal has the features below.

1) During the initial access, a baseband bandwidth of 5 MHz is used on a PDSCH and/or a PUSCH for transmission, and a baseband bandwidth of 20 MHz is used on other channels for uplink or downlink transmission.

After the initial access, optionally, the terminal may report to the network device that it may operate with a larger baseband bandwidth and/or a higher peak data rate, such as reporting whether it supports PDSCH and/or PUSCH transmission of 20 MHz.

2) The transmission of other physical channels and physical signals is still allowed to use the maximum 20 MHz BWP for transmission. The 20 MHz BWP may be an RF bandwidth and/or a BB bandwidth supported by the terminal.

3) The peak date rate is 10 Mbps; or the constraint

$${v}_{Layers}^{( j )} * {Q}_{m}^{( j )} * {f}^{( j )}$$

of the peak data rate is relaxed to less than or equal to 4. The peak data rate includes uplink and/or downlink peak data rates.

In one embodiment,

$${v}_{Layers}^{( j )} * {Q}_{m}^{( j )} * {f}^{( j )}$$

may have different values during the initial access and after completion of the initial access.

The above features may be used in combination, or only one feature is defined. For example, only peak data rate is defined to 10 Mbps.

Other features of the terminal may remain consistent with the original R17 Redcap terminal.

For example, it is mandatory for the terminal to support 8 Data Radio Bearers (DRBs).

It is mandatory for the terminal to support a 12-bit Packet Data Convergence Protocol (PDCP) sequence number (SN) and optionally supports an 18-bit PDCP SN.

It is mandatory for the terminal to support a 12-bit Radio Link Control (RLC) acknowledged mode (AM) SN and optionally supports an 18-bit RCL AM SN.

The terminal does not support features such as Dual Connectivity (DC), Carrier Aggregation (CA) and/or Integrated Access and Backhaul (IAB).

The terminal type may be only defined in the FR1.

The aforementioned terminal may be a Rel18 eRedCap terminal. In this case, the terminal may report a supportOfRedCap-r18 terminal to notify the network device of the first information. For example, Table 2 provides relevant parameter definition of the supportOfRedCap-r18 terminal, using the FR1 as an example:

TABLE 2

| | | | Difference |
|---|---|---|---|
| | Granularity | | between FDM |
| Parameter Definition | or unit (PER) | Mandatory? | and TDM |
| The supportOfRedCap-r18 terminal may have at | Granularity | Conditionally | Difference |
| least the following functions: | or unit (PER) | Mandatory | between FDM |
| using the FR1; | | | and TDM |
| 1) During the initial access, a baseband | | | |
| bandwidth of 5 MHz is used for a PUSCH and a | | | |
| PDSCH; and other channels use an FR bandwidth | | | |
| of 20 MHz for UL and DL transmission. | | | |
| After the initial access, the support for PDSCH | | | |
| and PUSCH transmission over 20 MHz BB may | | | |
| be optionally reported, and other channels support | | | |
| the transmission over 20 MHz RF bandwidth. | | | |
| 2) The transmission of other physical channels | | | |
| and physical signals is still allowed to use the | | | |
| maximum 20 MHz BWP for transmission, and the | | | |
| bandwidth of 20 MHz may be an RF bandwidth | | | |
| and/or a BB bandwidth supported by the terminal. | | | |
| 3) The relaxation of the maximum peak data rate | | | |
| may be limited to 10 Mbps. | | | |
| Conditions for the relaxation of the peak data rate | | | |
| may include: v_{Layers}^{(j)} * Qₘ^{(j)} * f^{(j)} not greater than 4. | | | |
| 4) An early indication of the PUSCH when using | | | |
| Msg1, MsgA, and/or Msg3 or msgA. | | | |
| 5) Independent initial UL BWP for the RedCap | | | |
| terminal; and | | | |
| independent initial DL BWP for the RedCap | | | |
| terminal. | | | |
| 6) Specific RRC configured DL BWP, where the | | | |
| DL BWP is associated with a cell defining | | | |
| synchronization signal block/physical broadcast | | | |
| channel block (CD-SSB), or a non-cell defining | | | |
| synchronization signal block/physical broadcast | | | |
| channel block (NCD-SSB). | | | |
| 7) NCD SSB measurement based on RRC | | | |
| configured DL BWP. | | | |

The embodiments of the present disclosure further protects a Rel-18 eRedCap terminal. The terminal may be a PR1 terminal exceeding 20M. Alternatively, the terminal may be referred to as a Rel-18 eRedCap BW3/PR3 terminal. The capability of the Rel-18 eRedCap BW3/PR3 terminal may be as follows:
a baseband bandwidth of 5 MHz is used on a PDSCH and/or a PUSCH for transmission, and a baseband bandwidth of 20 MHz is used on other channels for uplink or downlink transmission.

The transmissions of other physical channels and physical signals are still allowed to use the maximum 20 MHz BWP for transmission. The bandwidth of 20 MHz may be an RF bandwidth and/or a BB bandwidth supported by the terminal, with the peak data rate of 10 Mbps; or the constraint

$${v}_{Layers}^{( j )} * {Q}_{m}^{( j )} * {f}^{( j )}$$

of the peak data rate is relaxed to less than or equal to 4, such as 3.2. The peak data rate includes uplink and/or downlink peak data rates.

The R18 eRedCap BW3 type may be defined only in the FR1.

Other features of the terminal may remain consistent with the original R17 Redcap terminal.

For example, it is mandatory for the terminal to support 8 Data Radio Bearers (DRBs).

It is mandatory for the terminal to support a 12-bit Packet Data Convergence Protocol (PDCP) sequence Number (SN) and optionally supports an 18-bit PDCP SN.

It is mandatory for the terminal to support a 12-bit Radio Link Control (RLC) acknowledge mode (AM) SN and optionally supports an 18-bit RLC AM SN.

The terminal does not support DC, CA, etc.

The terminal may be an R18 eRedCap-BW3/PR3 terminal. In this case, the terminal may report a supportOfRedCapBW3PW3-r18 terminal to notify the network device. The table below provides relevant parameter definition for the supportOfRedCapBW3PW3-r18 terminal (defined in the FR1 as an example):

TABLE 3

| | | | Difference |
|---|---|---|---|
| | Granularity | Is M | between FDM |
| Parameter Definition | or unit (PER) | Mandatory? | and TDM |
| The supportOfRedCapBW3PR3-r18 terminal | Granularity | Conditionally | Difference |
| may have at least the following functions: | or unit (PER) | Mandatory | between FDM |
| A baseband bandwidth of 5 MHz is used for a | | | and TDM |
| PUSCH and a PDSCH; and other channels use an | | | |
| FR bandwidth of 20 MHz for UL and DL | | | |
| transmission. | | | |
| Other physical channels and physical signals use | | | |
| BWP, where the bandwidth of the BWP may be | | | |
| up to the sum of the RF bandwidth and the BB | | | |
| bandwidth that are supported by the terminal. | | | |
| The relaxation of the maximum peak data rate | | | |
| may be limited to 10 Mbps. | | | |
| Conditions for the relaxation of the peak data rate | | | |
| may include: v_{Layers}^{(j)} * Qₘ^{(j)} * f^{(j)} equal to 3 or 3.2. | | | |
| An early indication of the PUSCH when using | | | |
| Msg1, MsgA, and/or Msg3/msgA. | | | |
| Independent initial UL BWP for the RedCap | | | |
| terminal; and | | | |
| independent initial DL BWP for the RedCap | | | |
| terminal. | | | |
| Specific RRC configured DL BWP, where the DL | | | |
| BWP is associated with a cell defining | | | |
| synchronization signal block/physical broadcast | | | |
| channel block (CD-SSB), or a non-cell defining | | | |
| synchronization signal block/physical broadcast | | | |
| channel block (NCD-SSB). | | | |
| NCD SSB measurement based on RRC | | | |
| configured DL BWP. | | | |

For Rel-18 eRedCap: 20M+PR1 terminal may have the following features.

1) During the initial access, a baseband bandwidth of 5 MHz is used on a PDSCH and/or a PUSCH for transmission, and a baseband bandwidth of 20 MHz is used on other channels for uplink or downlink transmission.

After the initial access, optionally, the terminal may report to the network device that it can operate with a larger baseband bandwidth and/or a higher peak data rate, such as reporting whether it supports PDSCH and/or PUSCH transmission of 20 MHz.

2) The transmission of other physical channels and physical signals is still allowed to use the maximum 20 MHz BWP for transmission. The bandwidth of 20 MHz may be an RF bandwidth and/or a BB bandwidth supported by the terminal.

3) The peak date rate is 10 Mbps; or the constraint

$${v}_{Layers}^{( j )} * {Q}_{m}^{( j )} * {f}^{( j )}$$

of the peak data rate is relaxed to less than or equal to 4, such as 0.75. The peak data rate includes uplink and/or downlink peak data rates.

In one embodiment,

$${v}_{Layers}^{( j )} * {Q}_{m}^{( j )} * {f}^{( j )}$$

may have different values during the initial access and after completion of the initial access.

The above features may be used in combination, or one feature is simply defined, for example, the peak data rate is simply defined to 10 Mbps.

Other technical features may remain consistent with the original R17 Redcap terminal.

For example, the terminal is forced to support 8 Data Radio Bearers (DRBs).

The terminal is forced to support a 12-bit Packet Data Convergence Protocol (PDCP) sequence Number (SN) and optionally supports an 18-bit PDCP SN.

The terminal is forced to support a 12-bit RadioLink Control (RLC) acknowledged mode (AM) SN and optionally supports an 18-bit RCL AM SN.

The terminal does not support features such as DC, CA and/or IAB.

The terminal type may be defined simply in the FR1.

The terminal may be the Rel-18 eRedCap: 20M+PR1 terminal. The Table 4 below provides relevant parameter definition of the Rel-18 eRedCap: 20M+PR18 terminal:

TABLE 4

| | | | Difference |
|---|---|---|---|
| | Granularity | | between FDM |
| Parameter Definition | or unit (PER) | Mandatory? | and TDM |
| The supportOfRedCapPR1-r18 terminal may | Granularity | Conditionally | Difference |
| have the following functions: | or unit (PER) | Mandatory | between FDM |
| using FR1; | | | and TDM |
| during the initial access, a 5 MHz bandwidth for | | | |
| a PDSCH (unicast and broadcast) and a PUSCH, | | | |
| and a 20 MHz bandwidth for UL and DL; | | | |
| after the initial access, a 20 MHz BB bandwidth | | | |
| for the PDSCH (unicast and broadcast) and the | | | |
| PUSCH and a 20 MHz RF bandwidth for the UL | | | |
| and the DL are optionally reported; and | | | |
| Other physical channels and physical signals are | | | |
| still allowed to use BWP, where the BWP may be | | | |
| up to 20 MHz. | | | |
| The peak date rate is 10 Mbps; or the constraint | | | |
| v_{Layers}^{(j)} * Qₘ^{(j)} * f^{(j)} of the peak data rate is relaxed | | | |
| to less than or equal to 4, such as 0.75. The peak | | | |
| data rate includes uplink and/or downlink peak | | | |
| data rates. | | | |
| In one embodiment, v_{Layers}^{(j)} * Qₘ^{(j)} * f^{(j)} may have | | | |
| different values during the initial access and after | | | |
| completion of the initial access. | | | |
| Independent initial UL BWP for the RedCap | | | |
| terminal; | | | |
| independent initial DL BWP for the RedCap | | | |
| terminal; and | | | |
| ue-specific RRC configured DL BWP, | | | |
| associated with CD-SSB orNCD-SSB; | | | |
| ncd-ssb based measurement in the DL BWP | | | |
| configured for the terminal. | | | |
| The R18 RedCap PR1 UE is expected to set this | | | |
| field to be supported. | | | |

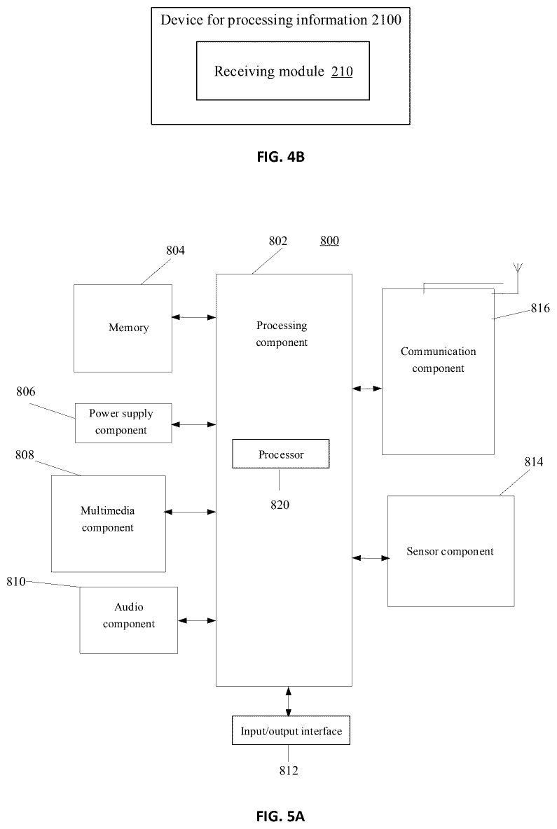

As shown in FIG. 4A, the embodiments of the present disclosure provide a device 1100 for processing information. The device 1100 includes:

a sending module 10, configured to send first information to a network device, where the terminal initially accesses a network in a first mode; and the first information is configured for the network device to determine whether the terminal supports or expects to operate in a second mode.

A peak data rate of the terminal operating in the second mode is higher than that of the terminal operating in the first mode; and/or a baseband bandwidth of a specified channel supported by the terminal operating in the second mode is greater than that of a specified channel supported by the terminal operating in the first mode.

In some embodiments, the device 1100 for processing information may include a terminal.

In some embodiments, the sending module 110 may be a program module. The program module, after executed by a processor, can perform the above operations.

In other embodiments, the sending module 110 may a hardware-software combined module. The hardware-software combined module includes, but is not limited to, a programmable array.

In yet other embodiments, the sending module 110 may be a pure hardware module. The pure hardware module includes, but is not limited to, an application-specific integrated circuit.

In some embodiments, the device 1100 for processing information further includes a storage module. The storage module is connected to the sending module and may be configured at least to store the first information.

It can be understood that the sending module 110 is configured to perform at least one of the following:
sending user equipment UE capability information to the network device, where the UE capability information indicates that the terminal has a capability to operate in the second mode;
sending UE Assistance information (UAI) to the network device, where the UAI indicates whether the terminal supports or expects to operate in the second mode;
sending the first information to the network device through an RRC message that enables the terminal to enter a radio resource control (RRC) connected state; or sending the first information to the network device through a message in a random access process.

It can be understood that the sending module 110 is further configured to send the first information to the network device through the message in the random access process.

It can be understood that the first information includes at least one of the following:
a preset parameter, where the preset parameter and a specified threshold are configured for the network device to determine whether the terminal supports or expects to operate in the second mode;
a first field, where the first field is configured to indicate whether the terminal supports or expects to operate in the second mode;
a second field, where the second field is configured to indicate whether the terminal supports a bandwidth for operating in the second mode; or
a third field, where the third field indicates that the terminal supports a reduction in a peak data rate, or indicates that the terminal supports a reduction in a baseband bandwidth.

It can be understood that the capability of the terminal to support or expect to operate in the second mode is based on a UE, a band, or a frequency range.

It can be understood that the device 1100 further includes:
a receiving module, configured to receive second information sent by the network device, where the second information is configured for the terminal to determine whether the first information is sent.

It can be understood that the second information includes at least one of the following:
a first indication, indicating whether the terminal needs to report UAI;
a second indication, indicating whether the network device supports or activates the first mode; or
a third indication, indicating whether the network device is a predetermined type of device, where the predetermined type of device supports the first mode.

It can be understood that the sending module 110 is configured to perform at least one of the following:
sending the UAI containing the first information to the network device, upon determining, based on the first indication, that the UAI needs to be reported;
sending the first information to the network device, upon determining, based on the second indication, that the network device supports or has activated the first mode; or
sending the first information to the network device, upon determining, based on the third indication, that the network device is the predetermined type of device.

It can be understood that receiving the second information sent by the network device includes at least one of the following:
receiving a system information block sent by the network device, where the system information block includes the second information; or
receiving a dedicated message sent by the network device, where the dedicated message includes the second information

As shown in FIG. 4B, the embodiments of the present disclosure provide a device 2100 for processing information. The device includes:
a receiving module 210, configured to receive first information from a terminal, where the terminal initially accesses a network in a first mode; and the first information is configured for a network device to determine whether the terminal supports or expects to operate in a second mode.

A peak data rate of the terminal operating in the second mode is higher than that of the terminal operating in the first mode; and/or a baseband bandwidth of a specified channel supported by the terminal operating in the second mode is greater than that of a specified channel supported by the terminal operating in the first mode.

In some embodiments, the device 2100 for processing the information may be a network device. The network device includes, but is not limited to, a base station.

In some embodiments, the receiving module 210 may be a program module. The program module, after executed by a processor, can perform the above operations.

In other embodiments, the receiving module 210 may be a hardware-software combined module. The hardware-software combined module includes, but is not limited to, a programmable array, and the programmable array includes, but is not limited to, a field-programmable gate array and/or a complex programmable array.

In yet other embodiments, the receiving module 210 may include a pure hardware module. The pure hardware module includes, but is not limited to, an application-specific integrated circuit.

It can be understood that the receiving module 210 is configured to perform at least one of the following:
receiving user equipment UE capability information sent by the terminal, where the UE capability information indicates that the terminal has a capability to operate in the second mode;
receiving UE Assistance information (UAI) sent by the terminal, where the UAI indicates whether the terminal supports or expects to operate in the second mode; or
receiving the first information sent by the terminal through a message in a random access process.

It can be understood that the message in the random access process includes: a radio resource control RRCSetupComplete message.

It can be understood that the first information includes at least one of the following:
a preset parameter, where the preset parameter and a specified threshold are configured for the network device to determine whether the terminal supports or expects to operate in the second mode;
a first field, where the first field is configured to indicate whether the terminal supports or expects to operate in the second mode;
a second field, where the second field is configured to indicate whether the terminal supports a bandwidth for operating in the second mode; or
a third field, where the third field indicates that the terminal supports a reduction in a peak data rate, or indicates that the terminal supports a reduction in a baseband bandwidth.

It can be understood that the capability of the terminal to support or expect to operate in the second mode is based on a UE, a band, or a frequency range.

It can be understood that the device 2100 further includes:
a sending module, configured to send second information to the terminal, where the second information is configured for the terminal to determine whether the first information is sent.

In some embodiments, the second information includes at least one of the following:
a first indication, indicating whether the terminal needs to report UAI;
a second indication, indicating whether the network device supports or activates the first mode; or
a third indication, indicating whether the network device is a predetermined type of device, where the predetermined type of device supports the first mode.

In some embodiments, the sending module is configured to perform at least one of the following:
sending a system information block, where the system information block includes the second information; or
sending a dedicated message to the terminal, where the dedicated message includes the second information.

The embodiments of the present disclosure provide a communication device, including:
a memory that stores processor-executable instructions; and
a processor, connected to the memory, where the processor is configured to perform the method for processing information provided by any of the aforementioned technical solutions.

The processor may include various types of storage media. The storage media are non-transitory computer storage media capable of continuing to store information on them even after the communication device is powered off.

In the present disclosure, the communication device includes: a terminal and/or a network device.

The processor may be connected to the memory via a bus or by other means to read an executable program stored in the memory, for example, to perform at least one of the methods shown in FIGS. 2A to 2E and/or FIGS. 3A to 3E.

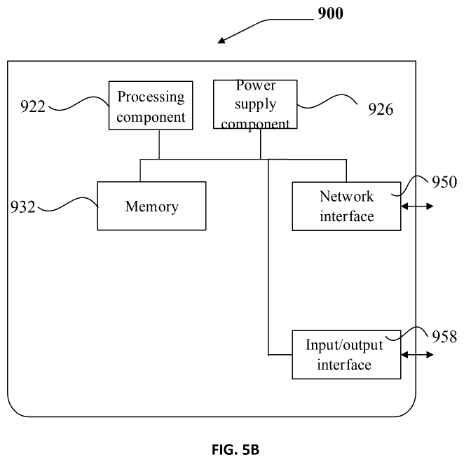

FIG. 5A is a block diagram of a terminal 800 according to an example. For example, the terminal 800 may be a mobile phone, a computer, a digital broadcast user device, a messaging device, a game console, a tablet device, a medical device, a fitness device, a personal digital assistant, etc.

Referring to FIG. 5A, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the terminal 800, such as operations associated with display, phone calls, data communication, camera operations, and recording operations. The processing component 802 may include one or more processors 820 to execute instructions to generate all or part of the steps of the above methods. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support the operation of the terminal 800. Examples of such data include instructions for any applications or methods operating on the terminal 800, contact data, phone book data, messages, pictures, videos, etc. The memory 804 may be implemented by any type of volatile or non-volatile storage device or a combination of them, such as a static random-access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk, or an optical disk.

The power supply component 806 supplies power to various components of the terminal 800. The power supply component 806 may include a power management system, one or more power sources, and other components associated with generating, managing, and distributing power for the terminal 800.

The multimedia component 808 includes a screen that provides an output interface between the terminal 800 and a user. In some embodiments, the screen may include a liquid crystal display (LCD) and a touch panel (TP). The screen, in a case of including a touch panel, may be implemented as a touch screen to receive an input signal from the user. The touch panel includes one or more touch sensors to sense touches, slides, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. The front camera and/or rear camera may receive external multimedia data, in a case where the terminal 800 is in an operating mode, such as a shooting mode or a video mode. Each of the front camera and the rear camera may be a fixed optical lens system or has focal length and optical zoom capability.

The audio component 810 is configured to output and/or input an audio signal. For example, the audio component 810 includes one microphone (MIC). The microphone is configured to receive an external audio signal, in a case where the terminal 800 is in the operating mode, such as a call mode, a recording mode, or a voice recognition mode. The received audio signal may be further stored in the memory 804 or sent via the communication component 816. In some embodiments, the audio component 810 also includes one speaker for outputting the audio signal.

The I/O interface 812 provides an interface between the processing component 802 and a peripheral interface module. The above peripheral interface may be a keyboard, a click wheel, buttons, etc. These buttons may include, but are not limited to: home buttons, volume buttons, start buttons, and lock buttons.

The sensor component 814 includes one or more sensors to provide state assessments for the terminal 800 in various aspects. For example, the sensor component 814 may detect an on/off state of the terminal 800 and a relative positioning of a component. For example, the component is the display and keypad of the terminal 800. The sensor component 814 may further detect a change in the position of the terminal 800 or one component of the terminal 800, the presence or absence of a contact between the user and the terminal 800, the orientation or acceleration/deceleration of the terminal 800, and a temperature change of the terminal 800. The sensor component 814 may include a proximity sensor configured to detect the presence of a nearby object without any physical contact. The sensor component 814 may also include a light sensor, such as a CMOS or CCD image sensor, for use in imaging applications. In some embodiments, the sensor component 814 may also include an accelerometer, a gyroscope sensor, a magnetic sensor, a pressure sensor, or a temperature sensor.

The communication component 816 is configured to facilitate communication between the terminal 800 and other devices in a wired or wireless manner. The terminal 800 may access a wireless network based on a communication standard such as Wi-Fi, 2G, or 3G, or a combination of them. In one example, the communication component 816 receives a broadcast signal or broadcast-related information from an external broadcast management system via a broadcast channel. In one example, the communication component 816 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In examples, the terminal 800 may be implemented by using one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to perform the above methods.

In examples, a non-transitory computer-readable storage medium is further provided, such as a memory 804 including instructions. The above instructions may be executed by the processor 820 of the terminal 800 to generate the above methods. For example, the non-transitory computer-readable storage medium may be an ROM, a random access memory (RAM), a CD-ROM, a magnetic tape, a floppy disk, an optical data storage device, etc.

As shown in FIG. 5B, an embodiment of the present disclosure illustrates a structure of a network device. For example, the network device 900 may be provided as a network-side device. This communication device may be various network elements such as the aforementioned access network element and/or network function.

Referring to FIG. 5B, the network device 900 includes a processing component 922, which further includes one or more processors; and a memory resource represented by the memory 932 for storing instructions that may be executed by the processing component 922, such as an application. The application stored in the memory 932 may include one or more modules, and each module corresponds to a set of instructions. In addition, the processing component 922 is configured to execute the instructions to implement any of the aforementioned methods applied to an access device, such as any one of the methods shown in FIGS. 2A to 2D, and/or FIGS. 3A to 3E.

The network device 900 may further include one power supply component 926 configured to execute power management of the network device 900, one wired or wireless network interface 950 configured to connect the network device 900 to a network, and one input/output (I/O) interface 958. The network device 900 may operate based on an operating system stored in the memory 932, such as Windows Server™ Mac OS X™, Unix™, Linux™, FreeBSD™, or similar. Each step in a certain implementation or embodiment may be implemented as an independent embodiment, and the steps may be combined arbitrarily, in a case of no contradictory. For example, a solution with some steps removed from a certain implementation or embodiment may also be implemented as an independent embodiment, and the order of the steps in a certain implementation or embodiment may be exchanged arbitrarily. In addition, optional methods or optional examples in a certain implementation or embodiment may be combined arbitrarily. Furthermore, various implementations or embodiments may be combined arbitrarily. For example, part or all of the steps of different implementations or embodiments may be combined arbitrarily, and a certain implementation or embodiment may be combined with optional methods or optional examples of other implementations of embodiments.

As used herein, the term processor may refer to one processor that performs the defined functions or a plurality of processors that collectively perform defined functions, such that the execution of the individual defined functions may be divided amongst such processors.

In some embodiments, terms such as “access network device (AN device),” “radio access network device (RAN device),” “base station (BS),” “radio base station,” “fixed station,” “node,” “access point,” “transmission point (TP),” “reception point (RP),” “transmission/reception point (TRP),” “panel,” “antenna panel,” “antenna array,” “cell,” “macro cell,” “small cell,” “femto cell,” “pico cell,” “sector,” “cell group,” “serving cell,” “carrier,” “component carrier,” and “bandwidth part (BWP)” may be interchangeable.

In some embodiments, terms such as “terminal,” “terminal device,” “user equipment (UE),” “user terminal,” “mobile station (MS),” “mobile terminal (MT),” “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” and “client” may be interchangeable.

In some embodiments, the access network device, the core network device, or the network device may be replaced by a terminal. For example, various embodiments of the present disclosure may further be applied to a structure where communication between the access network device, the core network device, or the network device and the terminal is replaced by communication among a plurality of terminals (e.g., also known as device-to-device (D2D), vehicle-to-everything (V2X), etc.). In this case, the terminal may be configured to a structure having all or part of the functions of the access network device. In addition, terms such as “uplink” and “downlink” may further be replaced with expressions corresponding to communication between terminals (e.g., “sidelink”). For example, uplink channels, downlink channels, etc. may be replaced with sidelink channels, and uplink, downlink, etc. may be replaced with sidelink.

In some embodiments, the terminal may be replaced by an access network device, a core network device, or a network device. In this case, the access network device, the core network device, or the network device may be configured to a structure having all or part of the functions of the terminal.

In some embodiments, names of information and the like are not limited to the names described in the embodiments. Terms such as “information,” “message,” “signal,” “signaling,” “report,” “configuration,” “indication,” “instruction,” “command,” “channel,” “parameter,” “domain,” “field,” “symbol,” “symbol,” “codebook,” “codeword,” “codepoint,” “bit,” “data,” “program,” and “chip” may be interchangeable.

In some embodiments, terms of “acquire,” “obtain,” “get,” “receive,” “transmit,” “bidirectional transmission,” and “send and/or receive” may be interchangeable and may be interpreted as receiving from another entity, acquiring from a protocol, obtaining by self-processing, achieving by self-implementation, and other meanings.

In some embodiments, terms such as “send,” “emit,” “report,” “issue,” “transmit,” “bidirectional transmission,” and “send and/or receive” may be interchangeable.

In some embodiments, “predetermined” and “preset” may be interpreted as predefined in a protocol or as a pre-set action by the device.

In some embodiments, “determining” may be interpreted as inferring, deciding, judging, calculating, computing, processing, deriving, investigating, seeking, looking up, search, inquiry, ascertaining, receiving, transmitting, input, output, accessing, resolving, selecting, choosing, establishing, comparing, assuming, expecting, considering, broadcasting, notifying, communicating, forwarding, configuring, reconfiguring, allocating, mapping, assigning, etc., but is not limited to this.

In some embodiments, determining or judging may be performed by using a value represented by 1 bit (0 or 1), by using a true or false value (boolean) represented by true or false, or by comparing numerical values (e.g., comparing with a predetermined value), but is not limited to this.

In some embodiments, terms such as “in response to . . . ,” “in response to determining . . . ,” “in a case where . . . ,” “when . . . ,” “upon . . . ,” “in the event of . . . ,” and “in a case of . . . ” may be interchangeable.

Those skilled in the art will readily think of other implementations of the present disclosure after considering the specification and practicing the present disclosure disclosed here. The present disclosure is intended to cover any variations, uses, or adaptations of the present disclosure. These variations, uses or adaptations follow the general principles of the present disclosure and include common general knowledge or conventional technical means in the field that are not disclosed in the present disclosure. The specification and the embodiments are considered as illustrative merely, and the true scope and spirit of the present disclosure are indicated by the following claims.

It is to be understood that the present disclosure is not limited to the precise structure already described and shown in the accompanying drawings, and various modifications and changes may be made without departing from the scope of the present disclosure. The scope of the present disclosure is limited merely by the appended claims.

1. A method for processing information, performed by a terminal, the method comprising:
sending first information to a network device, wherein the terminal initially accesses a network in a first mode, and the first information is configured for the network device to determine whether the terminal supports or expects to operate in a second mode.

2. The method according to claim 1, wherein the method further comprises at least one of the following:
a peak data rate of the terminal operating in the second mode is higher than that of the terminal operating in the first mode; or
a baseband bandwidth of a specified channel supported by the terminal operating in the second mode is greater than that of a specified channel supported by the terminal operating in the first mode.

3. The method according to claim 1, wherein sending the first information to the network device comprises at least one of the following:
sending user equipment (UE) capability information to the network device, wherein the UE capability information indicates that the terminal has a capability to operate in the second mode;
sending UE Assistance information (UAI) to the network device, wherein the UAI is configured to determine whether the terminal supports or expects to operate in the second mode;
sending the first information to the network device through a radio resource control (RRC) message that enables the terminal to enter an RRC connected state; or
sending the first information to the network device through a message in a random access process.

4. The method according to claim 3, wherein sending the first information to the network device through the RRC message that enables the terminal to enter the RRC connected state comprises:
sending the first information to the network device through the message in the random access process.

5. The method according to claim 1, wherein the first information comprises at least one of the following:
a preset parameter, wherein the preset parameter and a specified threshold are configured for the network device to determine whether the terminal supports or expects to operate in the second mode;
a first field, wherein the first field is configured to indicate whether the terminal supports or expects to operate in the second mode;
a second field, wherein the second field is configured to indicate whether the terminal supports a bandwidth for operating in the second mode; or
a third field, wherein the third field indicates that the terminal supports a reduction or increase in a peak data rate, or indicates that the terminal supports a reduction or increase in a baseband bandwidth.

6. The method according to claim 1, wherein a capability of the terminal to support or expect to operate in the second mode is based on a UE, a band, or a frequency range.

7. The method according to claim 1, further comprising:
receiving second information sent by the network device, wherein the second information is configured for the terminal to determine whether the first information is sent.

8. The method according to claim 7, wherein the second information comprises at least one of the following:
a first indication, indicating whether the terminal needs to report UE Assistance information (UAI);
a second indication, indicating whether the network device supports or activates the first mode; or
a third indication, indicating whether the network device is a predetermined type of device, wherein the predetermined type of device supports the first mode.

9. The method according to claim 8, wherein sending the first information to the network device comprises at least one of the following:
sending the UAI comprising the first information to the network device, upon determining, based on the first indication, that the UAI needs to be reported;
sending the first information to the network device, upon determining, based on the second indication, that the network device supports or has activated the first mode; or
sending the first information to the network device, upon determining, based on the third indication, that the network device is the predetermined type of device.

10. The method according to claim 7, wherein receiving the second information sent by the network device comprises at least one of the following:
receiving a system information block sent by the network device, wherein the system information block comprises the second information; or
receiving a dedicated message sent by the network device, wherein the dedicated message comprises the second information.

11. A method for processing information, performed by a network device, the method comprising:
receiving first information from a terminal, wherein the terminal initially accesses a network in a first mode, and the first information is configured for the network device to determine whether the terminal supports or expects to operate in a second mode.

12. The method according to claim 11, wherein the method further comprises at least one of the following:
a peak data rate of the terminal operating in the second mode is higher than that of the terminal operating in the first mode; or
a baseband bandwidth of a specified channel supported by the terminal operating in the second mode is greater than that of a specified channel supported by the terminal operating in the first mode.

13. The method according to claim 12, wherein receiving the first information from the terminal comprises at least one of the following:
receiving user equipment (UE) capability information sent by the terminal, wherein the UE capability information indicates that the terminal has a capability to operate in the second mode;
receiving UE Assistance information (UAI) sent by the terminal, wherein the UAI indicates whether the terminal supports or expects to operate in the second mode; or
receiving the first information sent by the terminal through a message in a random access process.

14. The method according to claim 13, wherein the message in the random access process comprises: a radio resource control (RRC) setup complete message.

15. The method according to claim 11, wherein the first information comprises at least one of the following:
a preset parameter, wherein the preset parameter and a specified threshold are configured for the network device to determine whether the terminal supports or expects to operate in the second mode;
a first field, wherein the first field is configured to indicate whether the terminal supports or expects to operate in the second mode;
a second field, wherein the second field is configured to indicate whether the terminal supports a bandwidth for operating in the second mode; or
a third field, wherein the third field indicates that the terminal supports a reduction or increase in a peak data rate, or indicates that the terminal supports a reduction or increase in a baseband bandwidth.

16. (canceled)

17. The method according to claim 11, further comprising:
sending second information to the terminal, wherein the second information is configured for the terminal to determine whether the first information is sent.

18. The method according to claim 17, wherein the second information comprises at least one of the following:
a first indication, indicating whether the terminal needs to report UE Assistance information (UAI);
a second indication, indicating whether the network device supports or activates the first mode; or
a third indication, indicating whether the network device is a predetermined type of device, wherein the predetermined type of device supports the first mode.

19. The method according to claim 17, wherein sending the second information to the terminal comprises at least one of the following:
sending a system information block, wherein the system information block comprises the second information; or
sending a dedicated message to the terminal, wherein the dedicated message comprises the second information.

20-21. (canceled)

22. A communication device, comprising:
one or more processors;
a memory, and an executable program stored in the memory and executable by the one or more processors, wherein the one or more processors, upon running the executable program collectively, cause the communication device to:
send first information to a network device, wherein a terminal initially accesses a network in a first mode, and the first information is configured for the network device to determine whether the terminal supports or expects to operate in a second mode.

23. A non-transitory computer storage medium storing an executable program, wherein the executable program, when executed by one or more processors, causes the one or more processors to perform the method for processing information according to claim 1.
